(19) United States
(12) Patent Application Publication
(10) Pub. No.: US 2018/0330393 A1
(43) Pub. Date: Nov. 15, 2018

(54) METHOD FOR EASY ACCESSIBILITY TO HOME DESIGN ITEMS

(71) Applicants: Elizabeth Leah Lipkowitz, Montreal (CA); Sharon Azrieli, Westmount (CA)

(72) Inventors: Elizabeth Leah Lipkowitz, Montreal (CA); Sharon Azrieli, Westmount (CA)

(21) Appl. No.: 15/975,094

(22) Filed: May 9, 2018

Related U.S. Application Data
(60) Provisional application No. 62/505,185, filed on May 12, 2017.

(51) Int. Cl. G06Q 30/02; G06Q 20/06; G06Q 30/06; G06N 3/02; G06T 7/11; G06K 9/62

(52) U.S. Cl. CPC G06Q 30/0215; G06Q 30/0236; G06Q 20/065; G06Q 30/0643; G06T 2207/20132; G06T 7/11; G06K 9/6215; G06K 9/6267; G06N 3/02

(57) ABSTRACT

The present invention relates to a method for remunerating users, for tagging items in a network based commerce system, comprising the steps of: providing a network based commerce system, which can be accessed by users; providing means for uploading photos to the network based commerce system; providing means for allowing the users to tag items in said uploaded photos; displaying at least one of the tags, and remunerating said user, for his tagging, if said tagged item has been sold.

### TECHNICAL FIELD

The present invention relates to home design items. More particularly, the present invention relates to an Internet based platform for making home designed merchandise easily accessible to the public.

### BACKGROUND

As of today, people are highly aware of their living environment. Therefore, it is not surprising that much devotion and enthusiasm are invested in home design and decoration. Furthermore, essential home items such as tables, cabinets, chairs, and sofas, that have been regarded in the past as functional, and basic, have become today a form of decorative art. In addition to their original function, these items serve today as a fashion statement. Typically, the home items are selected to match with the interior design of the room. Thus, in today's market, there are different designs of home items to match many personal preferences and interior room designs. These designed home items may be found, today, in stores, and over the Internet, in many shapes and colors for purchasing. However, the verity of these items it is enormous and sometimes overwhelming.

US 2016/086259 discloses a platform for allowing home improvement professionals, to upload their portfolios, to a network based commerce system such as a website. Users may then browse the content, for example by room, style, and metro area. The content is arranged in collections that are in part passively sorted, based upon user relevance. As disclosed in the publication, tags are shown on objects, for example within photos, for which there is more information. Nevertheless, the described platform is limited.

It would therefore be desired to propose a system void of these deficiencies.

### SUMMARY

It is an object of the present invention to provide an Internet based platform for making home designed merchandise easily accessible to the public.

It is another object of the present invention to provide a network based commerce system winch remunerates designers and users for tagging items for the benefit of buyers.

It is still another object of the present invention to provide a platform for easily selling and buying home designed items.

Other objects and advantages of the invention will become apparent as the description proceeds.

The present invention relates to a method for remunerating users, for tagging items in a network based commerce system, comprising the steps of: (a) providing a processor capable of hosting a network based commerce system and capable of interacting with users; (b) providing a network based commerce system, on said processor, which can be accessed by said users; (c) providing means for uploading at least one photo of at least one item, to said network based commerce system; (d) storing said at least one photo on a computer readable storage; (e) displaying at least one of said at least one photo in said network based commerce system; (f) providing a first pre-trained neural network for detecting at least one object, related to said at least one item, in said at least one photo; (g) defining regions of said detected object in said photo; (h) cutting said detected object from said at least one photo based on said object regions; (i) providing means for allowing said user to tag at least one item related to said cut object in said at least one photo; (j) displaying at least one of said tags, in relations to at least one item of said at least one photo, in said network based commerce system, for offering to sale said item; and (k) remunerating said user, for said tagging said item in said at least one photo, if said tagged item has been sold.

The present invention also relates to a method for remunerating users, for tagging items in a network based commerce system, comprising the steps of: (a) providing a processor capable of hosting a network based commerce system and capable of interacting with users; (b) providing a network based commerce system, on said processor, which can be accessed by said users; (c) providing means for uploading photos to said network based commerce system; (d) storing said uploaded photos on a computer readable storage; (e) displaying at least one of said uploaded photos in said network based commerce system; (f) creating a virtual account, for at least one user, of said network based commerce system, by storing at least one of said user's details, on a computer readable storage; (g) providing means for allowing said user to tag items in said uploaded photos; (h) displaying at least one of said tags, in relations to at least one item of at least one of said uploaded photos, in said network based commerce system, for offering to sale said item; and (i) remunerating said user, for said tagging said item in said photo, if said tagged item has been sold.

Preferably, the remunerating of the user is done by virtual money.

Preferably, the network based commerce system is an Internet website.

Preferably, the network based commerce system is a cellular application based site.

Preferably, the user is also remunerated for posting to a social media a photo of his tagged photo from the network based commerce system.

Preferably, the user can tag an item by clicking on said item and assigning a vendor to said item.

Preferably, the tag may include one or more of the following details: the vendor, the price, or the dimensions of the item.

### BRIEF DESCRIPTION OF THE DRAWINGS

The accompanying drawings, and specific references to their details, are herein used, by way of example only, to illustratively describe some of the embodiments of the invention.

In the drawings:

FIG. 1 is an example of a photo of a room, according to an embodiment of the invention.

FIG. 2 is an example of a photo of a room with a depicted open tag, according to an embodiment of the invention.

FIG. 3 is an example of a registration page, according to an embodiment of the invention.

FIG. 4 is an example of a photo of a room with available ratings and comments, according to an embodiment of the invention.

FIG. 5 is an example of a GUI of an account of a user, according to an embodiment of the invention.

FIG. 6 is a schematic diagram of the method for detecting home related items in a photo, according to an embodiment of the invention.

FIG. 7 is a schematic diagram of the method for classifying objects and finding similarities, according to an embodiment of the invention.

### DETAILED DESCRIPTION

The terms of “front”, “rear”, “down”, “up”, “bottom”, “upper”, “horizontal”, “vertical”, “right”, “left” or any reference to sides or directions are used throughout the description for the sake of brevity alone and are relative terms only and not intended to require a particular component orientation.

Hereinafter, parts, elements and components that are depicted in more than one figure are referenced by the same numerals.

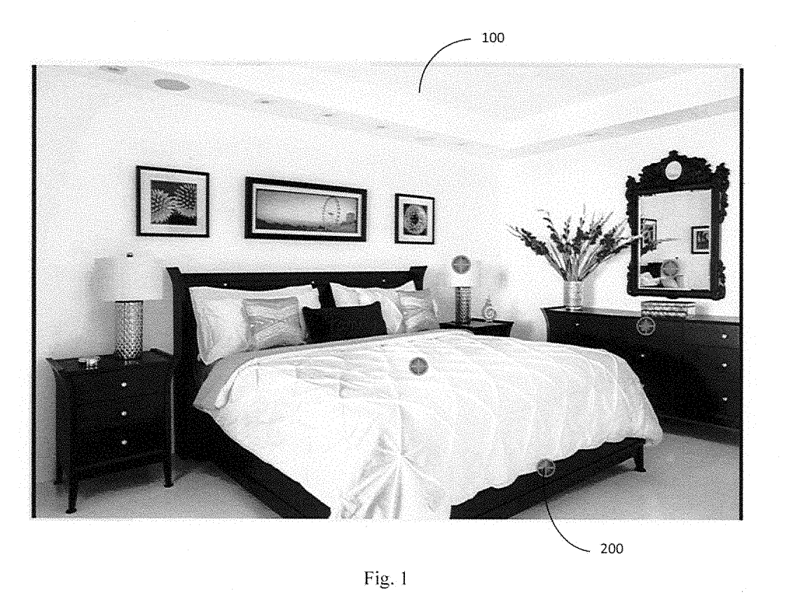

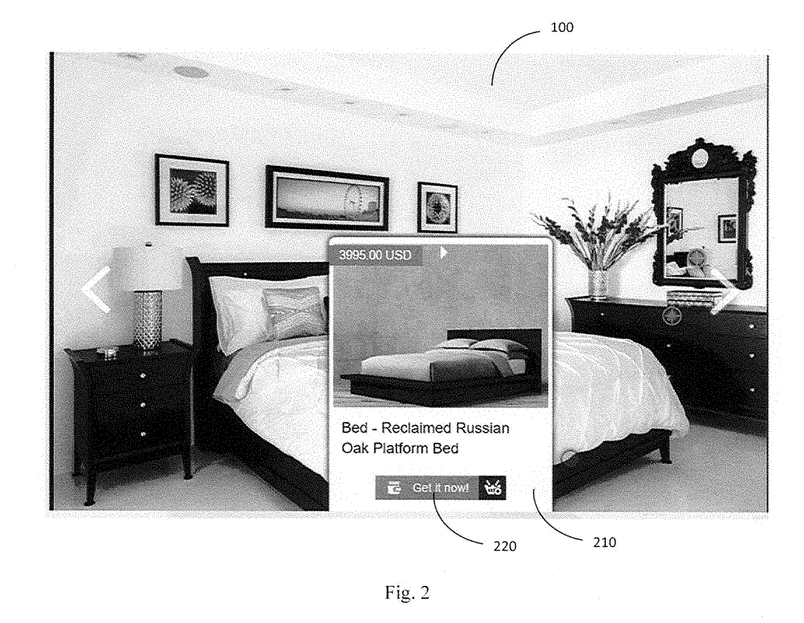

FIG. 1 is an example of a photo of a room, according to an embodiment of the invention. The photo 100 may be a part of a number of photos depicting rooms of a designed home, or a part of a design project, or a standalone picture of a room, or any other photo depicting items, e.g. merchandise. For example, in this photo the items may be a bed, a bed cover, a lamp, a mirror, a dresser, etc. In this example, the designer, or any other user, that uploaded the photo 100 can tag the bed for sale. Thus, the designer may tag the bed by adding a tag, to the bed in the photo, with information on the bed. For example, the designer may add, to the tag, information disclosing what kind of bed it is and/or the price, such as depicted in FIG. 2 for example. In some embodiments, a pointer, such as pointer 200, is added to the photo to signify that a tag exists for this item. In this embodiment, if a user clicks on pointer 200, views the tag, and buys the item then the designer who tagged the item is remunerated accordingly. For example, if a user buys the bed, depicted in photo 100, then the designer which tagged the bed will be remunerated accordingly, such as remunerated with a percentage of the sale.

The term “user” or “users” are meant to include any type of user including designers, manufacturers, and end users.

The terms “tag” and “tagging” are meant to include any information added to a photo in relations to a certain item such as one or more of the following: the price, the origin, the vendor, the dimensions of the item or any other useful information.

The photo 100 may be uploaded to a network based commerce system hosted on a processor. The network based system may be an Internet website, a cellular application based site, or any other platform that can be accessed by users for uploading photos, viewing them, and tagging them. The processor may be one or more processing machines, a server, a computer or any other processing machine(s) capable of hosting the network based commerce system and capable of communicating over the network. The processor may be communicated over the Internet, cellular net, or over any other known network communication. For example, the processor may be a server that is connected to the Internet which can host an interactive website. The processor, which communicates over the network, may provide means for uploading photos of a home design. For example, the hosted interactive website on the server may have a GUI for easily uploading photos. In some embodiments, the uploaded photos may be still pictures, interactive movable pictures, 3D pictures, videos, or any other visual representation of designed items. The uploaded photos may be stored on the processor's hard disk or on any computer readable storage such as flash disk, optical disc or over the cloud in a remote server. Thus, the processor can display the uploaded photos from the readable storage and display them to users on the network based commerce system, e.g. on an Internet website.

FIG. 2 is an example of a photo of a room with a depicted open tag, according to an embodiment of the invention. In this example, a user may click on a pointer related to the bed, such as pointer 200 described in relations to FIG. 1, where the tag can open up with information on the depicted bed. Thus, if the user decides to buy the bed, as depicted in the picture 100, he can click on the link “Get it now” 220, in the exampled open tag 210, which can open a box for completing the purchase, for example.

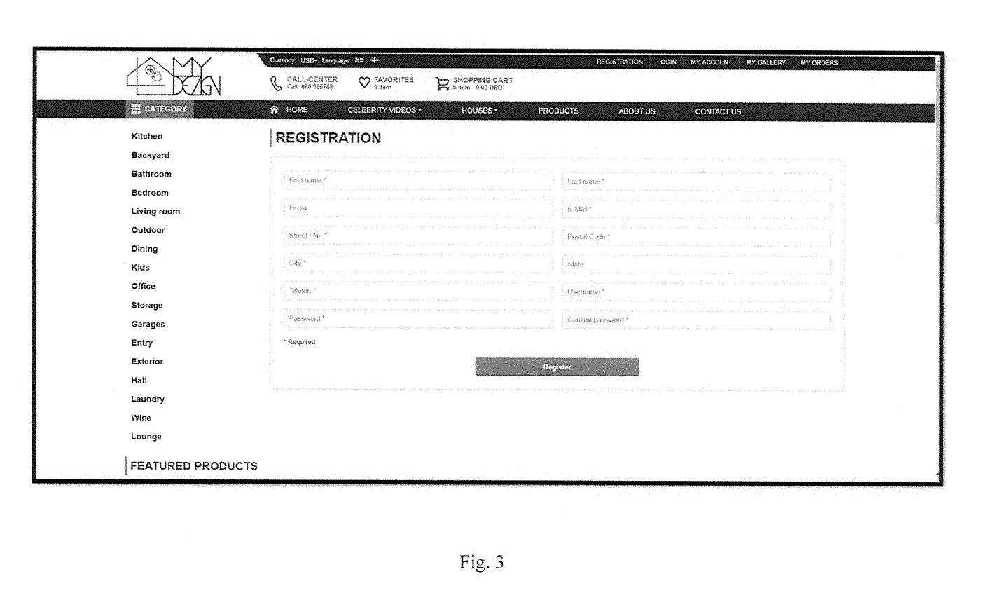

FIG. 3 is an example of a registration page, according to an embodiment of the invention. In this example, the user is required, at first, to fill in some of his details in order to create a virtual account. These details may be any personal details such as name, address, his preferred password, etc. These details may be stored, on a computer readable storage, for creating a virtual account for the user of this network based commerce system. Once a virtual account has been made, the user may login to the system, with his name and password, for example. In one embodiment, each registered user may be required to have a virtual account. The user of this network based commerce system may be any person who can access the system, such as a designer, a buyer, a seller of home improvements items, home décor enthusiasts, etc.

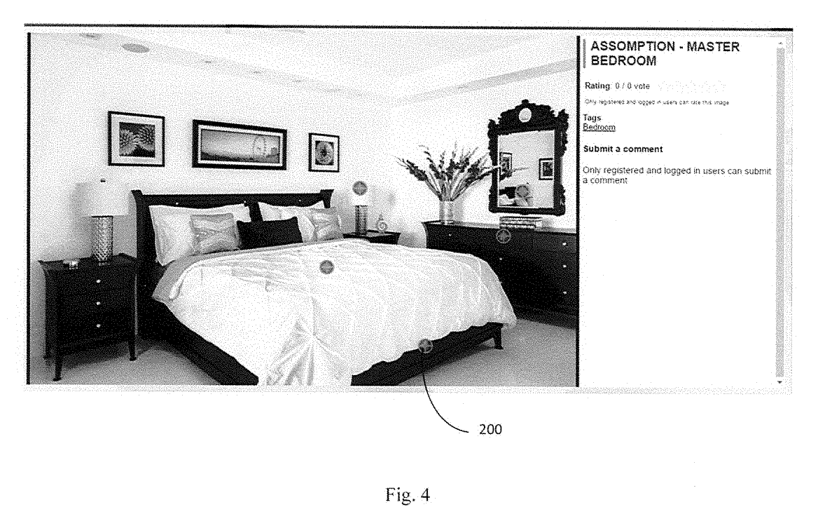

FIG. 4 is an example of a photo of a room with available ratings and comments, according to an embodiment of the invention. In this photo, the user may watch ratings and/or comments of other users. In addition, the user may also be given a place to comment on the photo, rate the photo, or tag items in the photo. In some embodiments, the users may rate and/or comment in relations to the whole photo and/or to items in the photo. Each comment or tag may be associated with the virtual account of the user who added the comment and tag. Each tag relates to a certain item in the picture. Thus, any other user which opens this photo can see pointers in the photo relating to the items in the photo. For example, if the user clicks on the pointer 200 a tag may jump forward revealing relevant information on the tagged item, e.g. the bed. Thus, the uploaded photos may be displayed together with their pointers and/or tags on this network based commerce system, e.g. Internet, website, for offering to sell home items. In one embodiment, if the tagged item is sold, then the user, who tagged the item, is remunerated for each tagged item that has been sold.

In one embodiment, if a sale is generated from a photo that was tagged, the user who did the tagging is remunerated in the form of virtual money. In one embodiment, the virtual money can be redeemed for real money, e.g. cash money, or can be used to purchase items on the network based commerce system. In one embodiment, the network based commerce system may automatically compute the remuneration, the moment a sale is generated, and may credit the tagging user's virtual account.

In one embodiment, the network based commerce system provides means for allowing a user to tag items in the uploaded photos. In one embodiment, the user must first isolate the item that he wishes to tag by clicking on it. In some embodiments, the user may select a vendor from a list of existing vendors and assign that vendor to the item. In some embodiments, if the vendor is not on the list, the user may add a manual tag and enter the details of the vendor, price, dimensions, or any other useful information. In some embodiments, the tag may be firstly reviewed by a professional of the network based commerce system, or anybody else assigned for the task. When the professional validates the details, of the tag, he can activate the tag thus making the item available for sale on the network based commerce system.

In some embodiments, if the manually assigned vendor, of the tagged item, is not in the list of existing vendors any one or more of the following options may occur;
1. The assigned vendor may be approached and offered to be part of the list of vendors, of the network based commerce system, after which the tag may be activated.
2. If another vendor, that it is listed on the list of existing vendors, carries the exact item, as the tagged item, the tag of the item may be altered to include the listed vendor, after which the tag may be activated.
3. If a vendor, that it is listed on the list of existing vendors, carries a similar item, to the tagged item, the tag of the item may be altered to include the listed vendor, after which the tag may be activated.
4. The manual tag may be sent back to the user for final approval, unless the user accepts the autotag attributed, to his photo, from the network based commerce system.

In one embodiment, the network based commerce system may be used for uploading photos, e.g. videos, of designed homes of famous celebrities, or known designers. In this embodiment, the photos may be uploaded by one user and tagged by another user. Furthermore, in one embodiment, the photos may be uploaded by any one, e.g. someone who is not necessarily a user of the network based commerce system. In this embodiment, after the photo has been uploaded and displayed, the users may recognize certain items in the photo. Thus, the users may tag the items they recognized for the benefit of other users who may be potential buyers. Thus, any user, watching the displayed photo of said designed home, may easily purchase an item displayed in the photo.

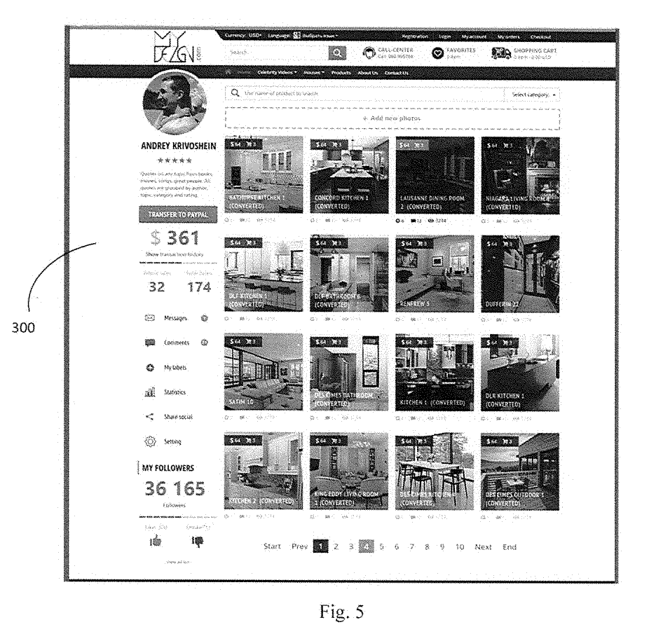

FIG. 5 is an example of a GUI of an account of a user, according to an embodiment of the invention. The GUI 300 of the account of the user may have personal information such as his name, picture, etc. together with other details of his virtual account such as how much virtual money he has earned. The GUI 300 may display photos, that the user has tagged, and/or photos that the user may wish to tag. In one embodiment, the user may be shown statistics concerning his tagging. In one embodiment, the user may also share his tagging with other friends, such as by social media.

In one embodiment, any user who posts to social media photos of their purchase, or their tagged photo from the network based commerce system, may also be remunerated for any other user who joins the network based commerce system as a result. In one embodiment, any user who posts to social media photos of their purchase, or their tagged photo from the network based commerce system, may also be remunerated for any other purchase made as a result of the social media post.

For the sake of brevity, a method for automatically detecting home interior items in photos is described below, where users can tag the automatically detected items in the photos.

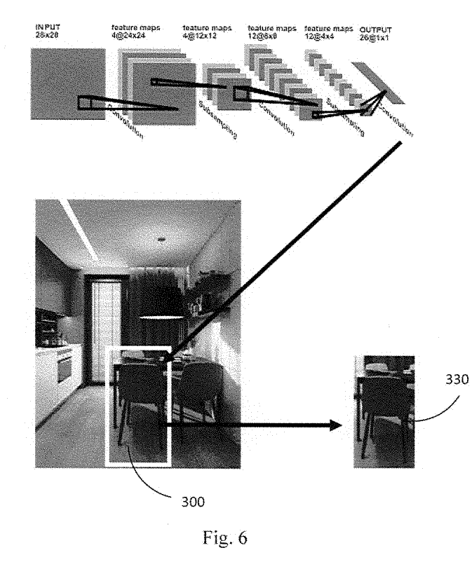

FIG. 6 is a schematic diagram of the method for detecting home related items in a photo, according to an embodiment of the invention. At first, the user may upload a photo, such as a JPEG image, of an interior of a room. When a user uploads a photo, to the platform, the system stores the uploaded photo on a computer readable storage. At step 1, a first pre-trained neural network operates on the photo for detecting objects in the photo. The pre-trained neural network may be a YOLO (You Only Look Once) neural network or any other module trained for detecting objects in the photo.

In one embodiment, the YOLO neural network is first pre-trained on a dataset such as the ImageNet dataset (http://www.image-net.org/) or on any other dataset, to detect interior objects in the photo and retrieve the object regions, e.g. x and y coordinates of the objects. In one embodiment, the YOLO neural network is pre-trained on home interior photos, where objects in the photo are already marked.

According to an embodiment, a YOLO neural network applies a single neural network to the full image. The network divides the image into regions and predicts bounding boxes and probabilities for each region. These bounding boxes are weighted by the predicted probabilities. Using a fully-convolutional model, it is possible to train on a whole image, and adjust priors on bounding boxes instead of predicting the width and height outright, effectively predicting the x and y coordinates of the objects directly. Thus, defining regions of each of the detected objects in the photo.

In one embodiment, the object detection area of the item, in the photo, must be at least 200×200 and at least 10% of the photo.

In one embodiment, API Methods, such as Django REST Framework, may be used for detecting in which area of photo the object is situated.

In FIG. 6, once the regions of the detected objects in the photo have been defined, then in step 2 the objects are cut from the photo based on the object's region. For example, the left chair 300 has been detected as an object, in the photo, and the object and his region have been cut as shown in photo 330. The cutting of an object can mean the separation (or copy and save) of the parts of the photo, that relate to an object, from the rest of the photo. In one embodiment the cut objects may be displayed to the users.

At this stage the user may tag one of the items related to the cut object in the photo. In one embodiment, the user may tag an item in the cut object and his tag may be shown to other users in relations to the uploaded full photo. In another embodiment, the user tags the item in the photo and his tag may be seen in relations to the item in the uploaded photo. In another embodiment, the users tag may be seen in relations to other similar item in other photos.

For the sake of brevity, a method for classifying objects from photos is described below.

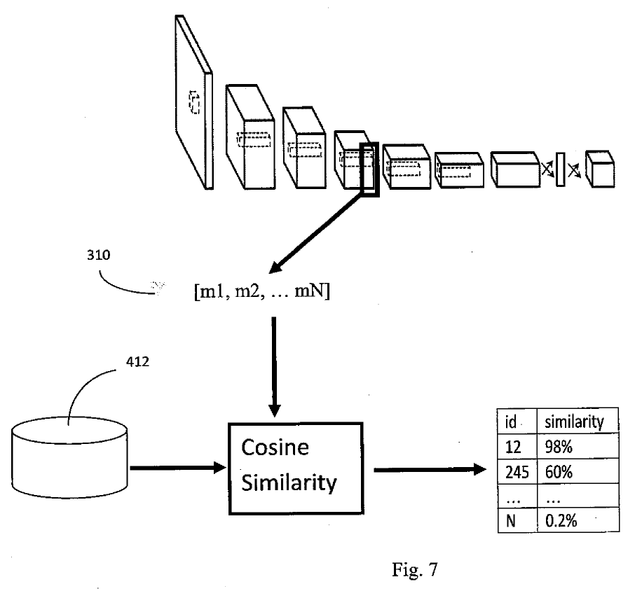

FIG. 7 is a schematic diagram of the method for classifying objects and finding similarities, according to an embodiment of the invention. In step 3, a second pre-trained neural network operates on the cut photo 330, described in relations to FIG. 6, for classifying the object. The second pre-trained neural network may be an AlexNet, resnet-32, resnet-50 or any other Convolutional Neural Network (CNN) pre-trained on a dataset, such as the ImageNet dataset, for classifying interior objects.

In one embodiment, the second pre-trained neural network is a pre-trained CNN that has been trained on images from the ImageNet Dataset. In some embodiments, the second pre-trained has a number of layers and can classify images into many object categories. In one embodiment, the CNN includes multiple hidden layers that process the output of the prior layer as receptive fields. Receptive fields areas of the processed input are neuron collections that each process a portion of the input image. The outputs of these collections are then tiled so that their input regions overlap, to obtain a higher-resolution representation of the original image. This process may be repeated for every such layer

In FIG. 7, in step 4, the feature vector 310 for the penultimate layer of the object is extracted. In some embodiments, the penultimate layer is used to speed up the classification process. The penultimate layer may have a set of values that may be used by the CNN to distinguish between the classes. In other words, the penultimate layer may he used as a meaningful and compact summary of the images, since it may contain enough information for the CNN to make a good classification based on a smaller set of values. In step 5, the feature vector 310 is then compared with other feature vectors from DB 412. DB 412 may contain a very large number of feature vectors of the penultimate layer of the many object of home interior items. In some embodiments, DB 412 may contain more than ten thousand feature vectors, however, in some embodiments, the comparison may be done only with the subset of the feature vectors with the same, or similar, classification. The comparison in step 5 may done using cosine similarity where the feature vector 310 is compared with other feature vectors from the same classification for finding the closest match. Once the closest match is found, the details of the item of the object of the closest feature vector may be displayed to the user. In one embodiment, only when the comparison produces a high result then an identical object has been found and the details of the item of the object of the closest feature vector may be displayed to the user. Since the “cosine similarity” between two vector spaces is a cosine of the angle between them, in one embodiment, when a cosine similarity is equal “1”, then the vectors are deemed the same. In one embodiment, when the comparison produces at least 98% similarity then the vectors are deemed the same. In one embodiment, the details of the item may comprise: descriptions, compare prices, and/or may offer to purchase the chosen item. In one embodiment, the user may be offered other similar items to choose from. For example, the user may use the method above inside a shop, by photographing an item in the shop, he may be offered similar products to compare with.

In one embodiment, the platform may be used for uploading photos of designed homes of famous celebrities or known designers. In this embodiment, the photos may be uploaded by a user and the platform may provide the user or other users details on the items shown. In an embodiment, after the photo has been uploaded, and items in the photo been detected, the users may recognize some of these items and tag them. Thus, the users may tag the items they recognized for the benefit of other users who may be potential buyers. Thus, any user, watching the displayed photo of said designed home, may easily purchase an item displayed in the photo.

While the above description discloses many embodiments and specifications of the invention, these were described by way of illustration and should not he construed as limitations on the scope of the invention. The described invention may be carried into practice with many modifications which are within the scope of the appended claims.

1. A method for remunerating users for tagging items in a network based commerce system comprising the steps of:
providing a processor capable of hosting a network based commerce system and capable of interacting with users;
providing a network based commerce system, on said processor, which can be accessed by said users;
providing means for uploading at least one photo of at least one item, to said network based commerce system;
storing said at least one photo on a computer readable storage;
displaying at least one of said at least one photo in said network based commerce system;
providing a first pre-trained neural network for detecting at least one object, related to said at least one item, in said at least one photo;
defining regions of said detected object in said photo;
cutting said detected object from said at least one photo based on said object regions;
providing means for allowing said user to tag at least one item related to said cut object in said at least one photo;
displaying at least one of said tags, in relations to at least one item of said at least one photo, in said network based commerce system, for offering to sale said item; and
remunerating said user, for said tagging said item in said at least one photo, if said tagged item has been sold.

2. A method according to claim 1, further comprising:
providing a second pre-trained neural network for classifying the cut object;
extracting a feature vector of said cut object;
comparing said feature vector of said cut object with feature vectors of other objects;
finding a similarity between said feature vector of said cut object and at least one other feature vector of another object for finding the details of the item related to said cut object; and
displaying details of said item related to said cut object.

3. A method according to claim 1, where the remunerating of the user is done by virtual money.

4. A method according to claim 1, where the network based commerce system is an Internet website.

5. A method according to claim 1, where the network based commerce system is a cellular application based site.

6. A method according to claim 1, where a user is also remunerated for posting to a social media a photo of his tagged photo from the network based commerce system.

7. A method according to claim 1, where the user can tag an item by clicking on said item and assigning a vendor to said item.

8. A method according to claim 1, where the tag may include one or more of the following details: the vendor, the price, or the dimensions of the item.

9. A method for remunerating users for tagging items in a network based commerce system comprising the steps of:
providing a processor capable of hosting a network based commerce system and capable of interacting with users;
providing a network based commerce system, on said processor, which can be accessed by said users;
providing means for uploading photos to said network based commerce system;
storing said uploaded photos on a computer readable storage;
displaying at least one of said uploaded photos in said network based commerce system;
creating a virtual account, for at least one user, of said network based commerce system, by storing at least one of said user's details, on a computer readable storage;
providing means for allowing said user to tag items in said uploaded photos;
displaying at least one of said tags, in relations to at least one item of at least one of said uploaded photos, in said network based commerce system, for offering to sale said item; and
remunerating said user, for said tagging said item in said photo, if said tagged item has been sold.

10. A method according to claim 9, where the remunerating of the user is done by virtual money.

11. A method according to claim 9, where the user can tag an item by clicking on said item and assigning a vendor to said item.

12. A method according to claim 9, where the tag may include one or more of the following details: the vendor, the price, or the dimensions of the item.
